(19) United States
(12) Patent Application Publication
(10) Pub. No.: US 2004/0080695 A1
(43) Pub. Date: Apr. 29, 2004

(54) VVA mode liquid crystal display

(76) Inventors: Sang Un Choi, Kyoungki-do (KR); Seong Wook Shin, Kyongki-do (KR); Seung Ho Hong, Kyoungki-do (KR); Jung Ho Ma, Kyoungki-do (KR)

Correspondence Address: LADAS & PARRY, 224 SOUTH MICHIGAN AVENUE, SUITE 1200, CHICAGO, IL, 60604, US

(21) Appl. No.: 10/602,947

(22) Filed: Jun. 24, 2003

(30) Foreign Application Priority Data
Jun. 27, 2002 (KR) 2002-36490

(51) Int. Cl. G02F 1/1337

(52) U.S. Cl. 349/130

(57) ABSTRACT

A valley vertical alignment (VVA) mode liquid crystal display includes lower and upper substrates oppositely arranged at a predetermined distance, a liquid crystal layer interposed between the upper and lower substrates and including liquid crystal molecules having a negative dielectric constant anisotropy, a pixel electrode formed on an inner surface of the lower substrate, a color resin layer formed on an inner surface of the upper substrate and having a “V”-shaped valley, an opposite electrode formed on the color resin layer including the “V”-shaped valley, vertical alignment layers interposed both between the pixel electrode and the liquid crystal layer and between the opposite electrode and the liquid crystal layer, and polarizing plates attached to each outer surfaces of the lower and upper substrates, with their polarizing axes crossing each other. According to the VVA mode liquid crystal display, a multi-domain can be formed without any additional masking process by forming the “V”-shaped valley through a mask change during formation of the color resin layer, and thus the manufacturing process and cost can be reduced.

### BACKGROUND OF THE INVENTION

1. Field of the Invention

The present invention relates to a liquid crystal display, and more particularly to a VVA (Valley Vertical Alignment) mode liquid crystal display that can achieve process simplification and cost saving.

2. Description of the Prior Art

As generally known in the art, a liquid crystal display (LCD) has been developed in place of a cathode-ray tube (CRT). Especially, since a TFT-LCD (Thin Film Transistor Liquid Crystal Display) can realize a high picture quality, large-sized, and colorful display screen which is equal to a CRT, it has been widely highlighted in the notebook PCs and monitors markets, and thus it is expected that it will even make inroads into TV markets.

The TFT-LCD described above has typically used a TN (Twisted Nematic) as its driving mode. However, since the TN mode has the characteristics of low viewing angle and response speed, its improvement has been in demand, and thus a VA (Vertical Alignment) mode, IPS (In-Plane Switching) mode, etc., have been proposed. Also, an OCB (Optically Compensated Bend) including an improved response speed characteristic, FLC (Ferroelectric Liquid Crystal), etc., has been proposed. In addition, a PDLC (Polymer Dispersed Liquid Crystal), the manufacturing process of which is simplified and which also requires no polarizing plate, is now under development.

Especially, the VA mode can not only improve its response speed and viewing angle but also abbreviate an alignment process, i.e., rubbing process, through the use of a vertical alignment layer, and many technical developments thereof are in progress.

In the VA mode LCD, although it is not illustrated, a liquid crystal layer including liquid crystal molecules having a negative dielectric constant anisotropy is interposed between upper and lower substrates provided with liquid crystal driving electrodes, vertical alignment layers are formed on surfaces of the upper and lower substrates opposite to each other, and polarizing plates are attached to back surfaces of the upper and lower substrates, respectively. Polarizing axes of upper and lower polarizing plates are formed so as to be perpendicular to each other.

Before an electric field is formed, the liquid crystal molecules are vertically arranged on the substrates under the influence of the vertical alignment layers, and at this time, the VA mode LCD presents a dark picture in relation to the vertical crossing of the upper and lower polarizing plates. Thereafter, if the electric field is formed between the liquid crystal driving electrodes of the upper and lower substrates, the liquid crystal molecules are twisted so that their major axes become perpendicular to the direction of the electric field, and thus light leaks out through the twisted liquid crystal molecules to present a white picture.

Meanwhile, in the VA mode LCD described above, the liquid crystal molecules have a refractive index anisotropy in relation to their form, which resembles a bar. Thus, the phase of the picture in view of the major axes of the liquid crystal molecules and the phase of the picture in view of the minor axes of the liquid crystal molecules become different from each other. Especially, since all the liquid crystal molecules make a vertical queue on the substrates before the electric field is formed, the front surface presents a complete dark state, but light leaks from its side surface, deteriorating the picture quality.

Accordingly, in order to prevent the deterioration of picture quality due to the refractive index anisotropy of the liquid crystal molecules as described above, diverse types of VA mode LCDs have been proposed. For example, an MVA (Multi-domain Vertical Alignment) mode LCD of Fujitsu Ltd., an ASV (Advanced Super View) mode LCD of Sharp Corporation, and a PVA (Patterned Vertical Alignment) mode LCD of Samsung Electronics Co., Ltd. have been mass-produced.

However, since each of the MVA, ASV, and PVA mode LCDs described above requires one more mask when it is manufactured, the manufacturing process and cost are increased in comparison to the typical VA or TN mode LCD.

Specifically, the MVA, ASA, and PVA modes are all modified driving modes in which the refractive index anisotropy characteristics of the liquid crystal molecules are compensated for through the formation of the multi-domain. As a means for forming the multi-domain, the MVA mode of Fujitsu Ltd. has a projection pattern formed on the upper substrate, and the PVA mode of Samsung Electronics Co., Ltd. has ITO (Indium Thin-Oxide) slits formed on the upper substrate.

However, in order to form the projection pattern or the ITO slits, one additional sheet of mask should be employed, and in addition, coating, hardening, exposure, developing, etching, and strip processing of photoresist should be performed. As a result, the MVA, ASV, and PVA modes require a complicated manufacturing process with the manufacturing cost increased in comparison to the typical VA and YN modes.

### SUMMARY OF THE INVENTION

Accordingly, the present invention has been made to solve the above-mentioned problems occurring in the prior art, and an object of the present invention is to provide a VVA mode LCD that can achieve process simplification and cost saving.

In order to accomplish this object, there is provided a valley vertical alignment (VVA) mode liquid crystal display which includes lower and upper substrates oppositely arranged at a predetermined distance, a liquid crystal layer interposed between the upper and lower substrates and including liquid crystal molecules having a negative dielectric constant anisotropy, a pixel electrode formed on an inner surface of the lower substrate, a color resin layer formed on an inner surface of the upper substrate and having a “V”-shaped valley, an opposite electrode formed on the color resin layer including the “V”-shaped valley, vertical alignment layers interposed both between the pixel electrode and the liquid crystal layer and between the opposite electrode and the liquid crystal layer, and polarizing plates attached to each outer surfaces of the lower and upper substrates, with their polarizing axes crossing each other.

Here, the “V”-shaped valley is provided to divide a unit pixel into at least two regions. For example, it is designed to have the shape of “+”, “×”, or a cramp.

Also, the pixel electrode is formed in a plate or slit structure, and divided into at least two parts in a unit pixel.

According to the present invention, a multi-domain can be formed without any additional masking process by forming the “V”-shaped valley through a mask change during formation of the color resin layer, and thus the increase of manufacturing processes and costs can be prevented.

### BRIEF DESCRIPTION OF THE DRAWINGS

The above and other objects, features and advantages of the present invention will be more apparent from the following detailed description taken in conjunction with the accompanying drawings, in which:

FIGS. 1A and 1B are views explaining a VVA mode LCD according to a first embodiment of the present invention;

FIGS. 2A and 2B are views explaining a VVA mode LCD according to a second embodiment of the present invention; and

FIGS. 3A to 3D are views explaining a multi-domain formation according to a “V”-shaped valley and pixel electrode structure.

### DETAILED DESCRIPTION OF THE PREFERRED EMBODIMENTS

Hereinafter, preferred embodiments of the present invention will be described with reference to the accompanying drawings. In the following description and drawings, the same reference numerals are used to designate the same or similar components, and so repetition of the description on the same or similar components will be omitted.

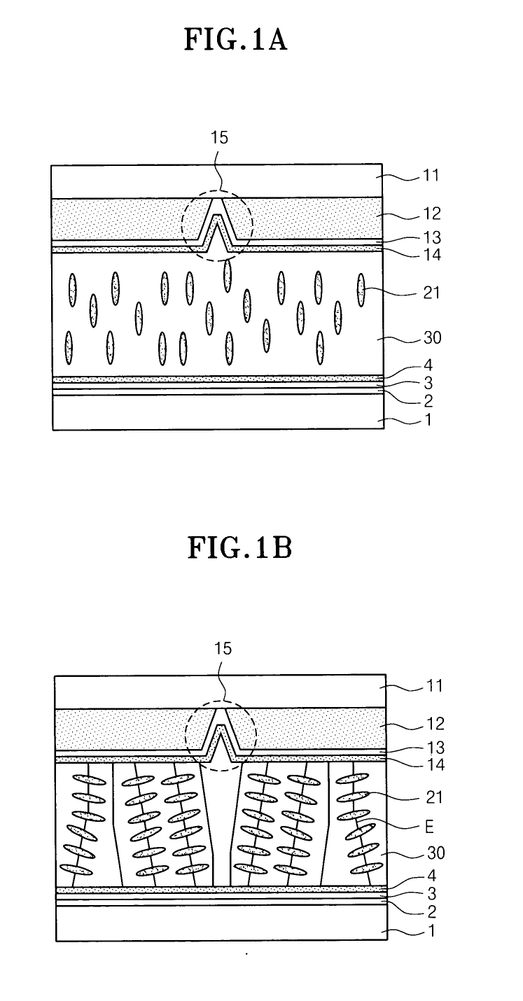

FIGS. 1A and 1B are views explaining a VVA mode LCD according to a first embodiment of the present invention. Here, FIG. 1A shows a cross section of the VVA mode LCD obtained before the electric field is formed, and FIG. 1B shows a cross section of the VVA mode LCD obtained after the electric field is formed.

As shown in FIGS. 1A and 1B, the VVA mode LCD according to the present invention has the structure in that a liquid crystal layer 30 including liquid crystal molecules 21 having a negative dielectric constant anisotropy is interposed between a lower substrate 1 provided with a pixel electrode 3 and an upper substrate 11 provided with an opposite electrode 13.

Also, vertical alignment layers 4 and 14 for liquid crystal alignment before the electric field is formed are installed on surfaces of the lower substrate 1 and the upper substrate 11 opposite to each other, and polarizing plates (not illustrated) are attached to the outer surfaces of each of the lower substrate 1 and the upper substrate 11. Polarizing axes of the upper and lower polarizing plates cross each other.

Especially, a color resin layer 12 is formed on an inner surface of the upper substrate 11, and the opposite electrode 13 is formed on the color resin layer 12. The vertical alignment layer 14 is formed on the opposite electrode 13, and a “V”-shaped valley 15 is provided on the color resin layer 12. Accordingly, the opposite electrode 13 and the vertical alignment layer are formed on the color resin layer 12 that includes the “V”-shaped valley 15.

The “V”-shaped valley 15 is formed through the mask change when the color resin layer of red (R), green (G) and blue (B) is formed. Accordingly, any separate mask and process for forming the “V”-shaped valley 15 is not required.

In FIGS. 1A and 1B, the reference numeral 2 denotes a gate insulating layer.

According to the VVA mode LCD according to the present invention as described above, as shown in FIG. 1A, the liquid crystal molecules 21 are vertically arranged on the substrates 1 and 11 under the influence of the vertical alignment layers 4 and 14 before the electric field is formed between the pixel electrode 3 and the opposite electrode 13.

Thereafter, as shown in FIG. 1B, if the electric field E is formed between the pixel electrode 3 and the opposite electrode 13, the liquid crystal molecules 21 are twisted so that their major axes become perpendicular to the direction of the electric field E, and at this time, distortion of the electric field occurs near the “V”-shaped valley 15, so that the liquid crystal molecules 21 form the multi-domain. As a result, phase retardation at an inclined viewing angle, which occurs due to the refractive index anisotropy, is compensated for.

Consequently, according to the VVA mode LCD of the present invention, the multi-domain is obtained by forming the “V”-shaped valley on the upper substrate through the mask change when the color resin layer is formed as the manufacturing process of the upper and lower substrates of the existing VA mode LCD is maintained as it is, the manufacturing process and cost can be reduced as the VVA mode LCD of the present invention has the same optical characteristic as the MVA mode LCD of Fujitsu Ltd., ASA mode LCD of Sharp Corporation, and PVA mode LCD of Samsung Electronics Co., Ltd.

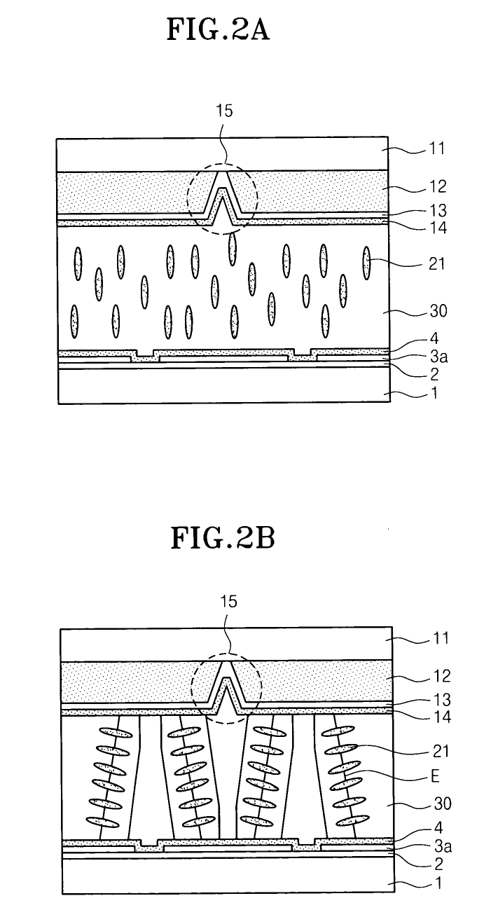

FIGS. 2A and 2B are views explaining a VVA mode LCD according to a second embodiment of the present invention. In this embodiment, the pixel electrode 3 of the upper substrate 1 has a slit structure, not the plate structure, and the remaining constituent elements are identical to those of the first embodiment. Also, only the shape of the pixel electrode is different, but the manufacturing process of the lower substrate 1 and the upper substrate 11 is identical to that of the first embodiment.

In the second embodiment, since the pixel electrode 3 of the lower substrate 1 is formed as the slit structure, it is easy to form the multi-domain, and the stabilization of the liquid crystal alignment can be achieved accordingly.

That is, as shown in FIG. 2A, the liquid crystal molecules 21 are vertically arranged on the substrates 1 and 11 under the influence of the vertical alignment layers 4 and 14 before the electric field is formed between the pixel electrode 3 and the opposite electrode 13. However, as shown in FIG. 2B, if the electric field E is formed between the pixel electrode 3 and the opposite electrode 13, the liquid crystal molecules 21 are twisted so that their major axes become perpendicular to the direction of the electric field. At this time, distortion of the electric field occurs near the “V”-shaped valley 15, and then the distortion of the electric field occurs once again due to the slit of the pixel electrode 3. Accordingly, the multi-domain is easily formed, and the stabilization of the liquid crystal alignment can be achieved accordingly.

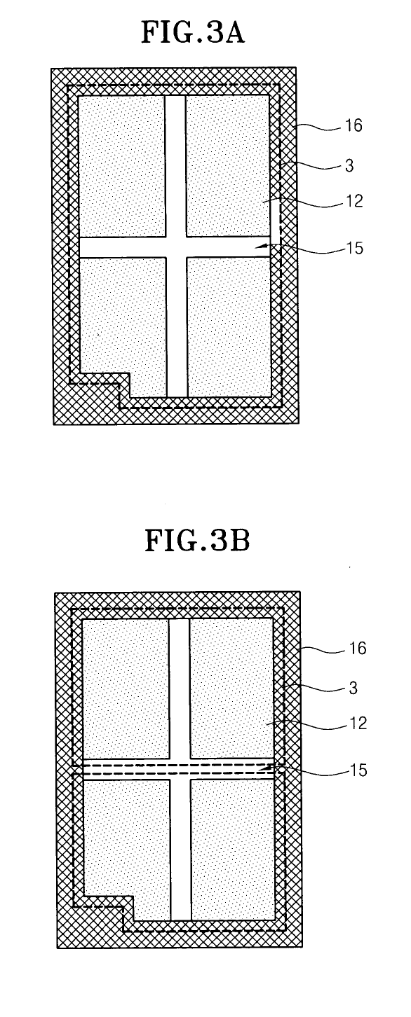

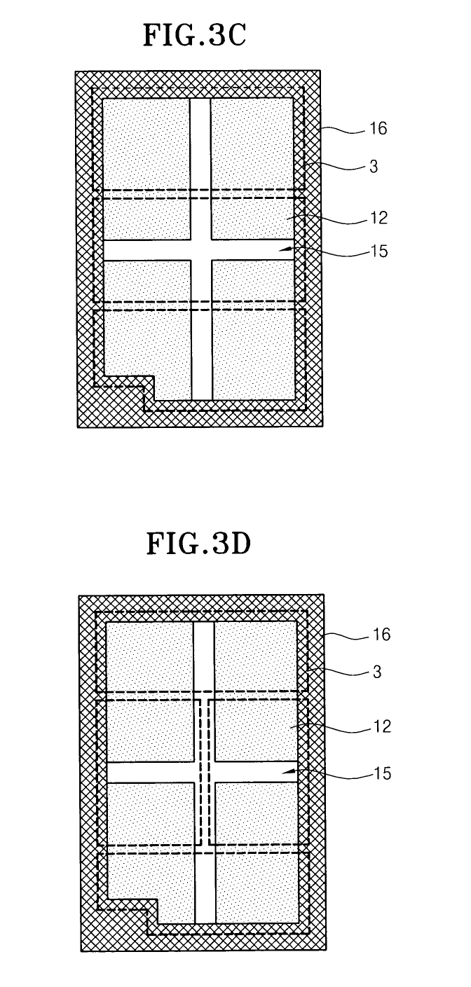

FIGS. 3A to 3D are views explaining a multi-domain formation according to a “V”-shaped valley and pixel electrode structure. Referring to FIGS. 3A and 3D, the “V”-shaped valley in the color resin layer may be formed to have the shape of “+”, which divides a unit pixel into four regions, and the pixel electrode may be formed to cover the whole pixel. Also, the pixel electrode may be formed to have two, three, or four divided parts. The reference numeral 3 denotes the pixel electrode, 13 the opposite electrode, 15 the “V”-shaped valley, and 16 a black matrix, respectively.

Referring to FIG. 3A, the “V”-shaped valley 15 is formed to have a “+” shape, the pixel electrode 3 is formed to have one part, and four liquid crystal domains are formed in the pixel.

Referring to FIG. 3B, the “V”-shaped valley 15 is formed to have a “+” shape, the pixel electrode 3 is formed to have two parts, and two liquid crystal domains are formed by the two divided pixel electrode parts to form the four liquid crystal domains in the pixel as a whole.

Referring to FIG. 3C, the “V”-shaped valley 15 is formed to have a “+” shape, and the pixel electrode 3 is formed to have three parts. Four liquid crystal domains are formed by the center one of the three divided pixel electrode parts, and four liquid crystal domains are formed between the center pixel electrode part and the upper pixel electrode part and between the center pixel electrode part and the lower pixel electrode part, resulting in that eight liquid crystal domains are formed as a whole.

Referring to FIG. 3D, the “V”-shaped valley 15 is formed to have a “+” shape, and the pixel electrode 3 is formed to have four regions. Four liquid crystal domains are formed by the two center divided pixel electrode parts, and four liquid crystal domains are formed between the center pixel electrode parts and the upper and lower pixel electrode parts, resulting in that eight liquid crystal domains are formed as a whole.

Meanwhile, the “V”-shaped valley and the pixel electrode may be formed with diversely changed shapes, and for example, the “V”-shaped valley may be formed to divide the unit pixel into four, eight, and ten pixel regions, respectively. Also, the “V”-shaped valley may be formed to have a shape of “×” and a cramp in addition to the shape of “+”, and to cope with this, the shape of the pixel electrode may be diversely changed as well.

By the combinations described above, the multi-domain can be easily formed, and thus the liquid crystal alignment can be stabilized.

As described above, according to the present invention, a multi-domain can be formed without any additional masking process by forming a “V”-shaped valley through a mask change during formation of a color resin layer, and thus the manufacturing process and cost can be reduced with the productivity and product competitiveness increased.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A valley vertical alignment (VVA) mode liquid crystal display comprising:
lower and upper substrates oppositely arranged at a predetermined distance;
a liquid crystal layer interposed between the upper and lower substrates and including liquid crystal molecules having a negative dielectric constant anisotropy;
a pixel electrode formed on an inner surface of the lower substrate;
a color resin layer formed on an inner surface of the upper substrate and having a “V”-shaped valley;
an opposite electrode formed on the color resin layer including the “V”-shaped valley;
vertical alignment layers interposed between the pixel electrode and the liquid crystal layer and between the opposite electrode and the liquid crystal layer, respectively; and
polarizing plates attached to outer surfaces of the lower and upper substrates, respectively, with their polarizing axes crossing each other.

2. The VVA mode liquid crystal display as claimed in claim 1, wherein the “V”-shaped valley is provided to divide a unit pixel into at least two regions.

3. The VVA mode liquid crystal display as claimed in claim 2, wherein the “V”-shaped valley is provided to have the shape of “+”, “×”, or a cramp.

4. The VVA mode liquid crystal display as claimed in claim 1, wherein the pixel electrode is formed in a plate or slit structure.

5. The VVA mode liquid crystal display as claimed in claim 4, wherein the pixel electrode is divided into at least two parts in a unit pixel.
